(19) United States
(12) Patent Application Publication
(10) Pub. No.: US 2004/0185239 A1
(43) Pub. Date: Sep. 23, 2004

(54) Interior member for vehicle and method of manufacturing interior member for vehicle

(75) Inventors: Tetsuya Nakamura, Kariya-shi (JP); Kazuo Tanabe, Kariya-shi (JP); Rintaro Senoo, Kariya-shi (JP); Tomohiko Ishihara, Kariya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYODA BOSHOKU CORPORATION, Kariya-shi (JP)

(21) Appl. No.: 10/755,271

(22) Filed: Jan. 13, 2004

(30) Foreign Application Priority Data
Jan. 14, 2003 (JP) 2003-006313

(51) Int. Cl. B32B 27/00

(52) U.S. Cl. 428/292.4; 428/500; 428/171

(57) ABSTRACT

The invention provides an interior member for a vehicle which has a sufficient noise absorbing property, prevents a thermoplastic resin from leaching out from a base material and prevents a surface of a skin material, that is, a design surface from being soiled, and a method of effectively manufacturing the interior member for the vehicle.

An interior member for a vehicle in accordance with the present invention is provided with a skin material, a base material and a bonding portion bonding the skin material and the base material and having a breathability,

the base material has an inorganic fiber (a glass fiber, a carbon fiber or the like) and/or a natural fiber (a linen, cotton or the like), and a thermoplastic resin (a polypropylene or the like) combining at least a part of a confounding point thereof the inorganic fiber and/or the natural fiber,

a melt flow rate of the thermoplastic resin measured in accordance with JIS K 7210 is 10 to 20 g per ten minutes,

a maximum size of the fiber in a diametrical direction is 3 to 50 μm, and

in case a total of the fiber and the thermoplastic resin is 100 wt %, the fiber is 55 to 40 wt % and the thermoplastic resin is 45 to 60 wt %.

### BACKGROUND OF THE INVENTION

1. Field of the Invention

The present invention relates to an interior member for a vehicle and a method of manufacturing an interior member for a vehicle. More particularly, the present invention relates to an interior member for a vehicle which has a sufficient noise absorbing property, prevents a thermoplastic resin from leaching out from a base material and prevents a surface of a skin material, that is, a design surface from being soiled, and a method of effectively manufacturing the interior member for the vehicle.

The present invention is widely used for the interior member for the vehicle such as a ceiling member or the like.

2. Description of the Prior Art

In conventional, there has been known an interior member for a vehicle formed by bonding a base material in which a confounding point of an inorganic fiber or the like, for example, a glass fiber or the like is combined by a thermoplastic resin, and a skin member constituted by a nonwoven fabric, a woven fabric, a polyvinyl chloride leather or the like. As the interior member for the vehicle, there is used a product in which the base material and the skin material are bonded by a hot melt adhesive, and a film layer having no breathability is formed between the base material and the skin material. Further, there has been employed a product in which a bonded portion between the base material and the skin material has a breathability.

In the product provided with the film layer having no breathability, a ventilation to the base material is shut off by the film layer, the skin material is prevented from being soiled due to attachment of dusts or the like within the vehicle to the skin material in accordance with the ventilation, and it is possible to inhibit a design property from being reduced. However, since the ventilation to the base material is shut off, the noise from an inner side of a passenger room can not be sufficiently absorbed, a noise absorbing property is reduced, and a quietness is deteriorated. On the other hand, in the product in which the bonded portion between the base material and the skin material has the breathability, since the air is flowed from the skin material to the base material, an excellent noise absorbing property is obtained. Further, in this product, since the film layer having no breathability is provided on an opposite surface of the base material to a surface to which the skin material is bonded, the ventilation is shut off, the surface of the skin material is prevented from being soiled, and it is possible to inhibit the design property from being reduced.

Further, it is necessary that the interior member for the vehicle is light, has a great strength and has a sufficient noise absorbing property. To that end, it is preferable that the base material itself has a great strength and a proper breathability. The base material can be formed by pressure molding the inorganic fiber or the like which is fibrillated and combined by a card machine or the like, and the thermoplastic resin fiber or the like. However, in the inorganic fiber or the like which is pressure molded, a thickness thereof can not be normally recovered sufficiently as it is, so that it is not easy to form the base material which is light and has a proper breathability. Accordingly, there has been known a method of laminating the thermoplastic resin film on both surfaces of a mat constituted by the inorganic fiber, laminating a sheet-like body made of a fiber reinforced polytetrafluoroethylene or the like on both the surfaces thereof, hot compressing, thereafter expanding the sheet-like body, and increasing a thickness of the mat (for example, refer to patent document 1).

### Patent Document 1

Japanese Unexamined Patent Publication No. Hei 1-166946

However, in the product in which the bonded portion between the base material and the skin material has the breathability, there is a problem that the thermoplastic resin combining the confounding point of the inorganic fiber or the like leaches out from the base material, and the surface of the skin material is soiled, so that the design property is lowered. Further, as described in the patent document 1, in the method of forming the base material by increasing the thickness of the mat after being pressure molded in accordance with a specific operation, a step of manufacturing the interior member for the vehicle is complicated, and it is impossible to produce efficiently.

### SUMMARY OF THE INVENTION

The present invention solves the conventional problem mentioned above, and an object of the present invention is to provide an interior member for a vehicle which has a sufficient noise absorbing property, can prevent a thermoplastic resin from leaching out from a base material, and can prevent a surface of a skin material, that is, a design surface from being soiled, and a method of efficiently manufacturing the interior member for the vehicle.

The present invention is as follows:

1. An interior member for a vehicle comprising:

a skin material;

a base material; and

a bonding portion bonding said skin material and said base material and having a breathability (gas permeability),

wherein said base material has an amount of metsuke (i.e. mass per unit aria) from 400 to 600 g/m², and has an inorganic fiber and/or a natural fiber, and a thermoplastic resin combining at least a part of a confounding point of said inorganic fiber and/or said natural fiber,

a melt flow rate of said thermoplastic resin measured in accordance with JIS K 7210 is 10 to 20 g per ten minutes,

an average maximum size of said inorganic fiber and/or said natural fiber in a diametrical direction is 3 to 50 μm, and in case a total of said inorganic fiber

and/or said natural fiber and said thermoplastic resin is 100 wt %, said inorganic fiber and/or said natural fiber is 55 to 40 wt % and said thermoplastic resin is 45 to 60 wt %.

In this case, the description “combining at least a part of a confounding point of the inorganic fiber and/or the natural fiber” means (1) combining at least a part of a confounding point between the inorganic fibers in the case of having only the inorganic fiber, (2) combining at least a part of a confounding point between the natural fiber in the case of having only the natural fiber, and (3) combining at least a part of each of a confounding point between the inorganic fibers, a confounding point between the natural fibers, and a confounding point between the inorganic fiber and the natural fiber in the case of having the inorganic fiber and the natural fiber.

Further, the description “an average maximum size of the inorganic fiber and/or the natural fiber in a diametrical direction is 3 to 50 μm” means (1) in the case of having only the inorganic fiber, an average maximum size thereof in a diametrical direction is 3 to 50 μm, (2) in the case of having only the natural fiber, an average maximum size thereof in a diametrical direction is 3 to 50 μm, and (3) in the case of having the inorganic fiber and the organic fiber, an average maximum size of both the fibers in a diametrical direction is 3 to 50 μm.

Further, the description “in case a total of the inorganic fiber and/or the natural fiber and the thermoplastic resin is 100 wt %, the inorganic fiber and/or the natural fiber is 55 to 40 wt % and the thermoplastic resin is 45 to 60 wt %” means (1) in the case of having only the inorganic fiber, a total of the inorganic fiber and the thermoplastic resin is 100 wt %, the inorganic fiber is 55 to 40 wt % and the thermoplastic resin is 45 to 60 wt %, (2) in the case of having only the natural fiber, a total of the natural fiber and the thermoplastic resin is 100 wt %, the natural fiber is 55 to 40 wt % and the thermoplastic resin is 45 to 60 wt %, (3) in the case of having the inorganic fiber and the natural fiber, a total of the inorganic fiber, the natural fiber and the thermoplastic resin is 100 wt %, the inorganic fiber and the natural fiber is 55 to 40 wt % and the thermoplastic resin is 45 to 60 wt %”

2. An interior member for a vehicle as recited in the item 1. mentioned above, wherein the thermoplastic resin is a polypropylene.

In the case that the thermoplastic resin is the polypropylene, it is possible to more inhibit the thermoplastic resin from leaching out from the base material, and the design property is not lowered.

3. A method of manufacturing an interior member for a vehicle provided with a skin material, a base material and a bonding portion bonding the skin material and the base material and having a breathability, comprising the steps of:

forming a base material constituted by a mixed fiber formed by mixing an inorganic fiber and/or a natural fiber, and a synthetic fiber comprising a thermoplastic resin in which a melt flow rate measured in accordance with JIS K 7210 is 10 to 20 g per ten minutes, and having an amount of metsuke from 400 to 600 g/m²;

thereafter laminating the base material and a skin material so as to form a laminated body;

next pressure molding the laminated body in a state in which the thermoplastic resin is melted so as to form a molded body;

thereafter depressurizing;

keeping the molded body at rest at a temperature equal to or more than a melting point of the thermoplastic resin so as to recover a thickness of the molded body; and

next cold molding.

In this case, the description “formed by mixing an inorganic fiber and/or a natural fiber, and a synthetic fiber comprising a thermoplastic resin in which a melt flow rate measured in accordance with JIS K 7210 is 10 to 20 g per ten minutes” means that the inorganic fiber and the synthetic resin are mixed, the natural fiber and the synthetic resin are mixed, or the inorganic resin, the natural resin and the synthetic resin are mixed.

4. A method of manufacturing an interior member for a vehicle as recited in the item 3. mentioned above, wherein the base material is formed by laminating a mat constituted by the mixed fiber so as to form a multilayer body, and thereafter applying a needle punch to the multilayer body.

In the case that the base material is formed by laminating the specific mat so as to form the multiple layer, and applying the needle punch to the multiple layer, it is possible to form the interior member for the vehicle which is sufficiently recovered in the thickness of the molded body after being pressure molded and is excellent in a noise absorbing property.

5. A method of manufacturing an interior member for a vehicle as recited in the item 4. mentioned above, wherein an average maximum size of the inorganic fiber and/or the natural fiber in the diametrical direction is 3 to 50 μm, and a fineness of the synthetic fiber is 3 to 20 d.

In the case that the average maximum size of the inorganic fiber and/or the natural fiber in the diametrical direction is 3 to 50 μm, and the fineness of the synthetic fiber is 3 to 20 d, the thickness of the molded body can be sufficiently recovered, and it is possible to more improve the noise absorbing property or the like.

6. A method of manufacturing an interior member for a vehicle as recited in the item 5. mentioned above, wherein on the assumption that the total of the inorganic fiber and/or the natural fiber and the synthetic fiber is 100 wt %, the inorganic fiber and/or the natural fiber is 55 to 40 wt %, and the synthetic resin is 45 to 60 wt %.

In the case of using the inorganic fiber and/or the natural fiber and the synthetic fiber by the specific rate, it is possible to improve a strength or the like, it is possible to further prevent the surface of the skin material from being soiled, and it is possible to prevent the design property from being lowered.

7. A method of manufacturing an interior member for a vehicle as recited in the item 6. mentioned above, wherein the thermoplastic resin is a polypropylene, and the compression molding temperature is 180 to 200° C.

In the case that the thermoplastic resin is the polypropylene, and the compression molding temperature is 180 to 200° C., it is possible to more securely prevent the surface of the skin material from being soiled, and it is possible to obtain the interior member for the vehicle having an excellent design property.

8. A method of manufacturing an interior member for a vehicle as recited in the item 7. mentioned above, wherein a temperature of the pressure molding is 10 to 50° C. higher than a melting point of the thermoplastic resin.

In the case that the temperature of the pressure molding is 10 to 50° C. higher than the melting point of the thermoplastic resin, the thermoplastic resin has a proper flowability, it is possible to improve a strength and it is possible to more securely prevent the thermoplastic resin from leaching out to the surface of the skin material.

9. A method of manufacturing an interior member for a vehicle as recited in the item 8. mentioned above, wherein a pressure of the pressure molding is 300 to 700 kPa, and a time thereof is 1 to 5 seconds.

In the case that the pressure of the pressure molding is 300 to 700 kPa, and the time thereof is 1 to 5 seconds, it is possible to efficiently produce a product which has a sufficient noise absorbing property and is not lowered in a design property.

10. A method of manufacturing an interior member for a vehicle as recited in the item 3. mentioned above, wherein an average maximum size of the inorganic fiber and/or the natural fiber in the diametrical direction is 3 to 50 μm, and a fineness of the synthetic fiber is 3 to 20 d.

11. A method of manufacturing an interior member for a vehicle as recited in the item 10. mentioned above, wherein on the assumption that the total of the inorganic fiber and/or the natural fiber and the synthetic fiber is 100 wt %, the inorganic fiber and/or the natural fiber is 55 to 40 wt %, and the synthetic resin is 45 to 60 wt %.

12. A method of manufacturing an interior member for a vehicle as recited in the item 11. mentioned above, wherein the thermoplastic resin is a polypropylene, and the compression molding temperature is 180 to 200° C.

13. A method of manufacturing an interior member for a vehicle as recited in the item 12. mentioned above, wherein a temperature of the pressure molding is 10 to 50° C. higher than a melting point of the thermoplastic resin.

14. A method of manufacturing an interior member for a vehicle as recited in the item 13. mentioned above, wherein a pressure of the pressure molding is 300 to 700 kPa, and a time thereof is 1 to 5 seconds.

15. A method of manufacturing an interior member for a vehicle as recited in the item 3. mentioned above, wherein on the assumption that the total of the inorganic fiber and/or the natural fiber and the synthetic fiber is 100 wt %, the inorganic fiber and/or the natural fiber is 55 to 40 wt %, and the synthetic resin is 45 to 60 wt %.

16. A method of manufacturing an interior member for a vehicle as recited in the item 15. mentioned above, wherein the thermoplastic resin is a polypropylene, and the compression molding temperature is 180 to 200° C.

17. A method of manufacturing an interior member for a vehicle as recited in the item 16. mentioned above, wherein a temperature of the pressure molding is 10 to 50° C. higher than a melting point of the thermoplastic resin.

18. A method of manufacturing an interior member for a vehicle as recited in the item 17. mentioned above, wherein a pressure of the pressure molding is 300 to 700 kPa, and a time thereof is 1 to 5 seconds.

19. A method of manufacturing an interior member for a vehicle as recited in the item 3. mentioned above, wherein the thermoplastic resin is a polypropylene, and the compression molding temperature is 180 to 200° C.

20. A method of manufacturing an interior member for a vehicle as recited in the item 19. mentioned above, wherein a temperature of the pressure molding is 10 to 50° C. higher than a melting point of the thermoplastic resin.

21. A method of manufacturing an interior member for a vehicle as recited in the item 20. mentioned above, wherein a pressure of the pressure molding is 300 to 700 kPa, and a time thereof is 1 to 5 seconds.

22. A method of manufacturing an interior member for a vehicle as recited in the item 3. mentioned above, wherein a temperature of the pressure molding is 10 to 50° C. higher than a melting point of the thermoplastic resin.

23. A method of manufacturing an interior member for a vehicle as recited in the item 22. mentioned above, wherein a pressure of the pressure molding is 300 to 700 kPa, and a time thereof is 1 to 5 seconds.

24. A method of manufacturing an interior member for a vehicle as recited in the item 3. mentioned above, wherein a pressure of the pressure molding is 300 to 700 kPa, and a time thereof is 1 to 5 seconds.

### BRIEF DESCRIPTION OF THE DRAWINGS

FIG. 1 is a schematic view showing schematically a cross section of a conventional interior material for a vehicle in which a surface of a skin material is prevented from being soiled due to ventilation; and

FIG. 2 is a schematic view showing schematically a cross section of an interior member for a vehicle in accordance with the present invention in which a thermoplastic resin is prevented from leaching out to a surface of a skin material and a sufficient noise absorbing property is provided.

### DESCRIPTION OF THE PREFERRED EMBODIMENT

A description will be in detail given below of the present invention.

### (1) Interior Member for Vehicle

The “skin material” mentioned above is structured such as to form a design surface of an interior member for a vehicle. As the skin material, there can be listed up a skin material formed by various nonwoven fabrics, woven fabrics, knitted fabrics, polyvinyl chloride leathers or the like, a skin material having an elastomer as a base material, and the like. Further, the “base material” mentioned above has the skin material bonded on one surface thereof and forms the interior member for the vehicle. On the basis of the base material, the interior member for the vehicle has a sufficient strength and buffering property. The “amount of metsuke” of the base material is 40 0 to 60 0 g/m², is preferably 450 to 550 g/m², and is more preferably 500 to 550 g/m². If the coating amount of the base material is less than 400 g/m², the strength of the interior member for the vehicle is lowered, and if it is more than 600 g/m², the interior member for the vehicle is heavy. Further, the “bonding portion” mentioned above bonds the skin material and the base material, and has the “breathability”. The degree of ventilation from the skin material to the base material can be appropriately adjusted while taking the noise absorbing property into consideration, as far as the noise absorbing property of the interior member for the vehicle is not greatly deteriorated.

The base material has the inorganic fiber and/or the natural fiber, and the thermoplastic resin bonding at least a part of a confounding point of these fibers.

As the “inorganic fiber” mentioned above, there can be listed up a glass fiber, a carbon fiber, a metal fiber and the like. Among them, the glass fiber and the carbon fiber are preferable. The glass forming the glass fiber is not particularly limited, and there can be listed up a glass containing such as Si, Al, and an alkali metal element such as Na, K and the like. The glass may include Mg, Ca and the like. Further, the glass may employ a glass containing B, a glass containing Pb, a borosilicic acid glass and the like containing Si, B, Al. The inorganic fiber may be constituted by one kind, or two or more kinds. Further as the “natural fiber” mentioned above, there can be listed up a vegetable fiber such as a linen, a cotton, a palm fiber, a coconut fiber or the like, an animal fiber such as a silk, a sheep wool or the like. The linen is preferable among them. One kind of natural fiber may be employed or two or more kinds of natural fibers may be employed. Further, the base material may have one or more kind of inorganic fibers and natural fibers.

Each of the inorganic fiber and the natural fiber is a fibrillated continuous fiber.

An average maximum size of the inorganic fiber and/or the natural fiber in the diametrical direction is 3 to 50 μm, is preferably 5 to 30 μm, and is more preferably 9 to 20 μm. If the maximum size of the fibers in the diametrical diction is less than 3 μm, the strength of the interior member for the vehicle is lowered, and if it is more than 50 μm, the interior member for the vehicle becomes heavy.

The “thermoplastic resin” mentioned above is mixed into the inorganic fiber and/or the natural fiber in an aspect of a fiber, a powder or the like, is melted at a time of pressure molding the skin material and the base material, and combines the confounding point of the inorganic resin and/or the natural fiber. As the thermoplastic resin, there can be listed up an olefin resin such as a polyethylene, a polypropylene, a polybutene, an ethylene-vinyl acetate copolymer or the like, an acrylic resin such as a polyacrylic methyl, a polyacrylic ethyl, a polymethacrylic acid methyl, a polymethacrylic acid ethyl or the like, apolyamide resin such as anylon-6, anylon-66, a nylon-12 or the like, a polyester resin such as a polyethylene terephthalate, a polycarbonate, or the like, and the like. Among them, the olefin resin, in particular, the polypropylene is preferable.

Only one kind of thermoplastic resin may be employed, or two or more kinds of thermoplastic resins may be employed.

In this case, it is possible to blend an additive which is normally used in this kind of resin, such as a lubricant, an antioxidant, an ultraviolet rays absorbing agent, an antistatic agent or the like, in the thermoplastic resin as occasion demands.

The melt flow rate (hereinafter, refer to “MFR”) measured in accordance with JIS K 7210 is 10 to 20 g per ten minutes, is preferably 10 to 18 g per ten minutes, and is particularly preferably 10 to 15 g per ten minutes. If the MFR of the thermoplastic resin is 10 to 20 g per ten minutes, the thermoplastic resin does not excessively fluidize at a time of pressure molding the skin material and the base material. Accordingly, the thermoplastic resin does not leach out from the bonding portion to the skin material, and it is possible to prevent the design property from being lowered due to the soiling of the surface of the skin material, that is the design surface of the interior member for the vehicle. Further, the fibers are not excessively bonded between the inorganic fibers and/or the natural fibers by the easily flowing thermoplastic resin. Accordingly, since it is possible to prevent a rigidity of the molded body from being too high at a time of pressure molding, the thickness is sufficiently recovered in the case of removing the pressure and leaving at rest, and it is possible to form the base material having a proper breathability.

The MFR is measured in accordance with a method A of JIS K 7210 “flow test method of thermoplastic resin”. Further, a testing temperature and a testing load are set to a temperature and a load which are generally applied to the MFR from 10 to 20 g per ten minutes in a condition of each of resins in Table 2 “testing condition in each of generally used resins” of the standard. For example, in the polyethylene, they are set to 190° C. and 21.18 N, and in the polypropylene, they are set to 230° C. and 21.18 N.

If the MFR of the thermoplastic resin is less than 10 g per ten minutes, the flowability is low. Accordingly, particularly, in the case that the inorganic fiber and/or the natural fiber, the thermoplastic resin fiber, the thermoplastic resin powder and the like are not sufficiently mixed, the confounding point of the inorganic fiber and/or the natural fiber is not sufficiently combined, so that the strength of the base material is lowered. On the other hand, if the MFR is more than 20 g per ten minutes, the thermoplastic resin fluidizes excessively, and leaches out to the surface of the skin material, that is, the design surface of the interior member for the vehicle, so that the design property is lowered due to the soiling.

In case a total of the inorganic fiber and/or the natural fiber and the thermoplastic resin is 100 wt %, the inorganic fiber and/or the natural fiber is 40 to 55 wt % and the thermoplastic resin is 45 to 60 wt %. Further, it is preferable that the inorganic fiber and/or the natural fiber is 43 to 52 wt % and the thermoplastic resin is 48 to 57 wt %, and it is particularly preferable that the inorganic fiber and/or the natural fiber is 45 to 50 wt % and the thermoplastic resin is 50 to 55 wt %. If the inorganic fiber and/or the natural fiber is less than 40 wt %, that is, the thermoplastic resin is more than 60 wt %, the thermoplastic resin leaches out to the surface of the skin, that is, the design surface of the interior member for the vehicle at a time of pressure molding the skin material and the base material, and the design property is lowered due to the soiling. On the other hand, if the inorganic fiber and/or the natural fiber is more than 55 wt %, that is, the thermoplastic resin is less than 45 wt %, the confounding point of the inorganic fiber and/or the natural fiber is not sufficiently combined, so that the strength of the base material is lowered.

In this case, the film layer having no breathability can be provided in an opposite surface to the surface of the base material to which the skin material is bonded. Accordingly, the ventilation all around the interior member for the vehicle in the thickness direction is shut off, whereby it is possible to prevent the surface of the skin material from being soiled, so that it is possible to achieve the interior member for the vehicle having a more excellent design property.

### (2) Method of Manufacturing Interior Member for Vehicle

The interior member for the vehicle in accordance with the present invention can be manufactured by forming a base material constituted by a mixed fiber formed by mixing an inorganic fiber and/or a natural fiber, and a synthetic fiber comprising a thermoplastic resin in which a melt flow rate measured in accordance with JIS K 7210 is 10 to 20 g per ten minutes, thereafter laminating the base material and a skin material, pressure molding the laminated body in a state in which the thermoplastic resin is melted so as to form a molded body, thereafter depressurizing, keeping the molded body at rest at a temperature equal to or more than a melting point of the thermoplastic resin so as to recover a thickness of the molded body, and next cold molding.

As the synthetic resin, it is possible to employ a synthetic resin constituted by the thermoplastic resin mentioned above, and it is preferable that the fineness thereof is 3 to 20 d.

The inorganic fiber and/or the natural fiber and the synthetic fiber can be mixed while fibrillating the raw material fiber of each of the fibers by an apparatus such as a card machine or the like. A method of forming the base material from the obtained mixed fiber is not particularly limited, and the mixed fiber may be formed as a mat having a predetermined thickness so as to be set as the base material. Further, the structure may be made such that the thin mat constituted by the mixed fiber is taken out from the card machine or the like used for regulating the mixed fiber, the mat is overlapped with each other and laminated so as to form a multilayer body, and a needle punching is applied to the multilayer body so as to form the base material. As the base material, a base material obtained by applying the needle punching to the multilayer body is preferable. If this base material is employed, it is possible to easily and sufficiently recover the thickness of the base material by leaving the base material at rest after depressurizing.

In the case of laminating the skin material and the base material and pressure molding, it is possible to laminate the base material previously heated to a predetermined temperature, and the skin material, and pressure mold. Further, it is possible to laminate the skin material and the base material, heat the laminated body to a predetermined temperature and pressure mold. The heating temperature of the base material and the laminated body is not particularly limited, however, it is preferable that the heating temperature is 10 to 50° C., in particular, 20 to 40° C. higher than a melting point of the thermoplastic resin forming the used synthetic resin. If the pressure molding is performed within the temperature range, the synthetic resin is easily melted, and is properly fluidized. As a result, the thickness of the molded body is sufficiently recovered, the thermoplastic resin does not leach out to the surface of the skin material, and the design property is not lowered.

In particular, in the case that the synthetic fiber is constituted by the polypropylene, it is preferable to pressure mold in a state in which the temperature of the base material is 180 to 200° C. If the pressure molding is performed in a state in which the base material is within the temperature range, the polypropylene fiber is easily melted and fluidized, the inorganic fiber and/or the natural fiber is properly combined, the thickness of the molded body is sufficiently recovered, and the design property is not lowered due to leaching out of the polypropylene to the surface of the skin material.

Further, it is preferable that the pressure for the pressure molding is 300 to 700 kPa, particularly 350 to 650 kPa, and more particularly 400 to 600 kPa, and the time is 1 to 5 seconds, particularly 2 to 4 seconds. The inorganic fiber and/or the natural fiber is properly combined by specifying the MFR of the thermoplastic resin without relation to the kind of the thermoplastic resin, as far as the pressure and the time for the compression molding are in the range mentioned above. Accordingly, the thickness of the molded body is sufficiently recovered, the thermoplastic resin does not leach out to the surface of the skin material, and the design property is not lowered.

In accordance with the manufacturing method of the present invention, the MFR of the thermoplastic resin forming the synthetic fiber combining the confounding point of the inorganic fiber and/or the natural fiber is set to be lower than the conventional one, and the melted thermoplastic resin has a proper fluidization. Accordingly, it is possible to form the base material properly combined between the fibers. Further, in the case of depressurizing after pressure molding the skin material and the base material, the melted thermoplastic resin can easily follow the deformation generated at a time when the pressurized inorganic resin and/or natural fiber is going to return to the original shape. As a result, in this base material, it is possible to recover the thickness to 50-85% of the thickness before the pressure molding with no additional operation after pressure molding. Further, in the case of using the base material obtained by applying the needle punch to the multilayer body formed by laminating the thin mat, it is possible to more easily recover the thickness of the base material.

### Embodiment

A description will be in particular described of the present invention on the basis of an embodiment.

A base material having a thickness from 6 to 8 mm is formed by picking up a mixed fiber of a glass fiber having an average maximum size in a diametrical direction of 15 μm and a polypropylene fiber having MFR from 10 to 15 g per ten minutes and having a fineness of 6 d (wt ratio 50: 50), which are regulated by a card machine, as a mat having a thickness of 1 mm from the card machine, folding the map so as to form a multilayer body comprising forty layers, and applying a needle punching.

Thereafter, a laminated body is formed by heating the base material at 240° C., and overlapping the heated base material and a skin material with interposing a hot melt adhesive as a bonding material between the heated base material and the skin material constituted by a nonwoven fabric and having a thickness from 18 to 25 μm, and next, a molded body having a thickness from 2 to 3 mm is formed by pressurizing the laminated body under a pressure from 300 to 700 kPa for 1 to 5 seconds. Next, in the case of measuring the thickness of the base material after depressurizing and leaving the base material at rest at a temperature from 180 to 200° C. for 5 to 10 seconds, the thickness is 5 to 6 mm, and is recovered to about 80 % of the thickness before the pressure molding.

The ceiling member for the vehicle having the predetermined shape and size is manufactured by mounting the molded body as it is in the molding die having a room temperature (25 to 35° C.), and cold molding.

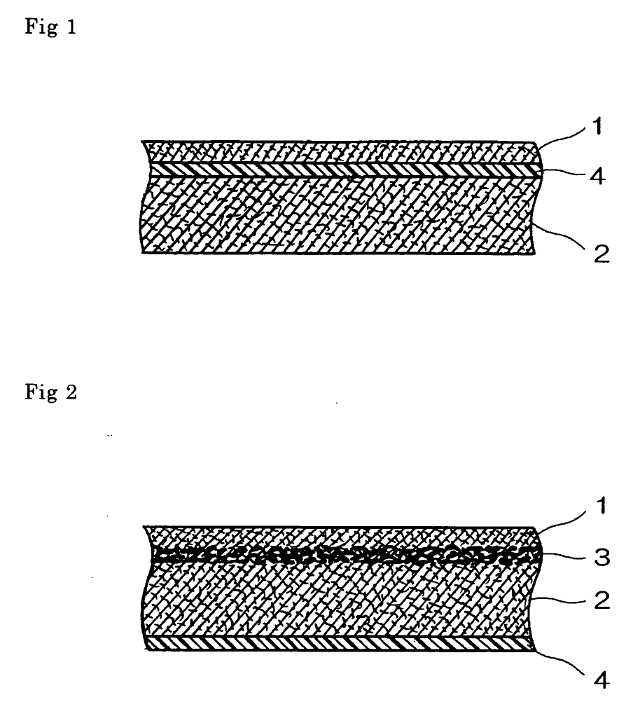

The interior member for the vehicle is structured, as shown in FIG. 2, such that the bonding portion 3 is formed between the skin material 1 and the base material 2. This bonding portion is formed by the bonding material melting and fluidizing between the skin material and the base material, and making an intrusion into the portion between the glass fibers, and has a suitable breathability. Further, the interior member for the vehicle shown in FIG. 2 is provided with the adhesive film layer 4 having no breathability on an opposite surface to the surface of the base material to which the skin material is bonded. This film layer is the same as the adhesive film layer 4 having no breathability in the conventional interior member for the vehicle shown in FIG. 1.

The interior member for the vehicle in accordance with this embodiment is provided with the structure shown in FIG. 2, and has a breathability from the skin material to the base material. Accordingly, a sufficient noise absorbing property is provided, it is possible to inhibit the thermoplastic resin from leaching out from the base material, and it is possible to prevent the surface of the skin material, that is, the design surface from being soiled. Further, the film layer having no breathability is provided on the opposite surface to the surface of the base material to which the skin material is bonded. Accordingly, it is possible to shut off the ventilation all around the entire of the thickness of the interior member for the vehicle, and it is possible to prevent the skin material from being soiled due to the attachment of the dusts or the like in the passenger room caused by the ventilation, whereby it is possible to inhibit the design property from being lowered.

In this case, the present invention is not limited to the particular embodiment mentioned above, and can employ an embodiment which are variously modified within the scope of the present invention in correspondence to the purpose and the intended use. For example, the base material may be arranged in the skin material side, and may be formed by a layer employing a thermoplastic resin in which the MFR is 10 to 20 g per ten minutes, and another layer employing a thermoplastic resin in which the MFR is higher than 20 g per ten minutes as in the conventional one. In accordance with the base material having the double layers, it is possible to prevent the thermoplastic resin from leaching out to the surface of the skin material, on the basis of the layer arranged in the skin material side. Further, it is possible to prevent the thermoplastic resin from leaching out to the surface of the skin material, on the basis of the base material formed by a nonwoven fabric arranged in the skin material side and in which the amount of metsuke is about 70 to 100 g/m², and another layer employing the thermoplastic resin in which the MFR is higher than 20 g per ten minutes as in the conventional one.

The interior member for the vehicle in accordance with the present invention has a sufficient noise absorbing property, it is possible to inhibit the thermoplastic resin from leaching out from the base material, it is possible to prevent the surface of the skin material from being soiled, and the design property is not deteriorated.

Further, in accordance with the manufacturing method of the interior member for the vehicle on the basis of the present invention, it is possible to efficiently produce the product which has a sufficient noise absorbing property and is not lowered in the design property.

What is claimed is:

1. An interior member for a vehicle comprising:
a skin material;
a base material; and
a bonding portion bonding said skin material and said base material and having a breathability,
wherein said base material has an amount of metsuke from 400 to 600 g/m², and has an inorganic fiber and/or a natural fiber, and a thermoplastic resin combining at least a part of a confounding point of said inorganic fiber and/or said natural fiber,
a melt flow rate of said thermoplastic resin measured in accordance with JIS K 7210 is 10 to 20 g per ten minutes,
an average maximum size of said inorganic fiber and/or said natural fiber in a diametrical direction is 3 to 50 μm, and
in case a total of said inorganic fiber and/or said natural fiber and said thermoplastic resin is 100 wt %, said inorganic fiber and/or said natural fiber is 55 to 40 wt% and said thermoplastic resin is 45 to 60 wt %.

2. An interior member for a vehicle according to claim 1, wherein said thermoplastic resin is a polypropylene.

3. A method of manufacturing an interior member for a vehicle provided with a skin material, a base material and a bonding portion bonding said skin material and said base material and having a breathability, comprising the steps of:
forming said base material constituted by a mixed fiber formed by mixing an inorganic fiber and/or a natural fiber, and a synthetic fiber comprising a thermoplastic resin in which a melt flow rate measured in accordance with JIS K 7210 is 10 to 20 g per ten minutes, and having an amount of metsuke from 400 to 600 g/m²;
thereafter laminating said base material and a skin material so as to form a laminated body;
next pressure molding said laminated body in a state in which said thermoplastic resin is melted so as to form a molded body;
thereafter depressurizing;
keeping said molded body at rest at a temperature equal to or more than a melting point of said thermoplastic resin so as to recover a thickness of said molded body; and
next cold molding.

4. A method of manufacturing an interior member for a vehicle according to claim 3, wherein said base material is formed by laminating a mat constituted by said mixed fiber so as to form a multilayer body, and thereafter applying a needle punch to said multilayer body.

5. A method of manufacturing an interior member for a vehicle according to claim 4, wherein an average maximum size of said inorganic fiber and/or said natural fiber in the diametrical direction is 3 to 50 μm, and a fineness of said synthetic fiber is 3 to 20 d.

6. A method of manufacturing an interior member for a vehicle according to claim 5, wherein in case the total of said inorganic fiber and/or said natural fiber and said synthetic fiber is 100 wt %, said inorganic fiber and/or said natural fiber is 55 to 40 wt %, and said synthetic resin is 45 to 60 wt %.

7. A method of manufacturing an interior member for a vehicle according to claim 6, wherein said thermoplastic resin is a polypropylene, and said compression molding temperature is 180 to 200° C.

8. A method of manufacturing an interior member for a vehicle according to claim 7, wherein a temperature of said pressure molding is 10 to 50° C. higher than a melting point of said thermoplastic resin.

9. A method of manufacturing an interior member for a vehicle according to claim 8, wherein a pressure of said pressure molding is 300 to 700 kPa, and a time thereof is 1 to 5 seconds.

10. A method of manufacturing an interior member for a vehicle according to claim 3, wherein an average maximum size of said inorganic fiber and/or said natural fiber in the diametrical direction is 3 to 50 μm, and a fineness of said synthetic fiber is 3 to 20 d.

11. A method of manufacturing an interior member for a vehicle according to claim 10, wherein in case the total of said inorganic fiber and/or said natural fiber and said synthetic fiber is 100 wt %, said inorganic fiber and/or said natural fiber is 55 to 40 wt %, and said synthetic resin is 45 to 60 wt %.

12. A method of manufacturing an interior member for a vehicle according to claim 11, wherein said thermoplastic resin is a polypropylene, and said compression molding temperature is 180 to 200° C.

13. A method of manufacturing an interior member for a vehicle according to claim 12, wherein a temperature of said pressure molding is 10 to 50° C. higher than a melting point of said thermoplastic resin.

14. A method of manufacturing an interior member for a vehicle according to claim 13, wherein a pressure of said pressure molding is 300 to 700 kPa, and a time thereof is 1 to 5 seconds.

15. A method of manufacturing an interior member for a vehicle according to claim 3, wherein in case the total of said inorganic fiber and/or said natural fiber and said synthetic fiber is 100 wt %, said inorganic fiber and/or said natural fiber is 55 to 40 wt %, and said synthetic resin is 45 to 60 wt %.

16. A method of manufacturing an interior member for a vehicle according to claim 15, wherein said thermoplastic resin is a polypropylene, and said compression molding temperature is 180 to 200° C.

17. A method of manufacturing an interior member for a vehicle according to claim 16, wherein a temperature of said pressure molding is 10 to 50° C. higher than a melting point of said thermoplastic resin.

18. A method of manufacturing an interior member for a vehicle according tom claim 17, wherein a pressure of said pressure molding is 300 to 700 kPa, and a time thereof is 1 to 5 seconds.

19. A method of manufacturing an interior member for a vehicle according to claim 3, wherein said thermoplastic resin is a polypropylene, and said compression molding temperature is 180 to 200° C.

20. A method of manufacturing an interior member for a vehicle according to claim 19, wherein a temperature of said pressure molding is 10 to 50° C. higher than a melting point of said thermoplastic resin.

21. A method of manufacturing an interior member for a vehicle according to claim 20, wherein a pressure of said pressure molding is 300 to 700 kPa, and a time thereof is 1 to 5 seconds.

22. A method of manufacturing an interior member for a vehicle according to claim 3, wherein a temperature of said pressure molding is 10 to 50° C. higher than a melting point of said thermoplastic resin.

23. A method of manufacturing an interior member for a vehicle according to claim 22, wherein a pressure of said pressure molding is 300 to 700 kPa, and a time thereof is 1 to 5 seconds.

24. A method of manufacturing an interior member for a vehicle according to claim 3, wherein a pressure of said pressure molding is 300 to 700 kPa, and a time thereof is 1 to 5 seconds.
